(19) United States
(12) Patent Application Publication
(10) Pub. No.: US 2013/0159253 A1
(43) Pub. Date: Jun. 20, 2013

(54) DIRECTING A DATA REPLICATION ENVIRONMENT THROUGH POLICY DECLARATION

(71) Applicants: Rhett Dondi Dewall, Superior, CO (US); Heping Shang, Walnut Creek, CA (US)

(72) Inventors: Rhett Dondi Dewall, Superior, CO (US); Heping Shang, Walnut Creek, CA (US)

(73) Assignee: Sybase, Inc., Dublin, CA (US)

(21) Appl. No.: 13/326,928

(22) Filed: Dec. 15, 2011

(51) Int. Cl. G06F 17/30

(52) U.S. Cl. 707/634; 707/E17.005

(57) ABSTRACT

System, method, computer program product embodiments and combinations and sub-combinations thereof for directing a data replication environment through policy declaration are described. Aspects include identifying a policy declaration defining a replication environment, and processing the policy declaration to instantiate the replication environment according to parameters established in the policy declaration.

### BACKGROUND

1. Field of the Invention

The present invention relates generally to data processing environments and, more particularly, to a system providing methodology for directing a data replication environment through policy declaration.

2. Background Art

Computers are very powerful tools for storing and providing access to vast amounts of information. Computer databases are a common mechanism for storing information on computer systems while providing easy access to users. A typical database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a database management system or DBMS is typically provided as a software cushion or layer. In essence, the DBMS shields the database user from knowing or even caring about the underlying hardware-level details. Typically, all requests from users for access to the data are processed by the DBMS. For example, information may be added or removed from data files, information retrieved from or updated in such files, and so forth, all without user knowledge of the underlying system implementation. In this manner, the DBMS provides users with a conceptual view of the database that is removed from the hardware level. The general construction and operation of database management systems is well known in the art. See e.g., Date, C., “An Introduction to Database Systems, Seventh Edition”, Addison Wesley, 2000.

Increasingly, businesses run mission-critical systems which store information on database management systems. Each day more and more users base their business operations on mission-critical systems which store information on server-based database systems, such as Sybase® Adaptive Server® Enterprise (ASE) (available from Sybase, Inc. of Dublin, Calif.). As a result, the operations of the business are dependent upon the availability of data stored in their databases. Because of the mission-critical nature of these systems, users of these systems need to protect themselves against loss of the data due to software or hardware problems, disasters such as floods, earthquakes, or electrical power loss, or temporary unavailability of systems resulting from the need to perform system maintenance.

One well-known approach that is used to guard against loss of critical business data maintained in a given database (the “primary database”) is to maintain one or more standby or replicate databases. A replicate database is a duplicate or mirror copy of the primary database (or a subset of the primary database) that is maintained either locally at the same site as the primary database, or remotely at a different location than the primary database. The availability of a replicate copy of the primary database enables a user (e.g., a corporation or other business) to reconstruct a copy of the database in the event of the loss, destruction, or unavailability of the primary database.

Database replication technologies comprise a mechanism or tool for replicating (duplicating) data. A publisher describes what is to be pulled from a primary source (e.g., a primary database), and a subscriber describes which information will be replicated from any of its publishers. The data may also be transformed during this process of replication (e.g., into a format consistent with that of a replicate database).

In many cases, a primary database may publish (i.e., make available for replication) items of data to a number of different subscribers. Also, in many cases, each of these subscribers is only interested in receiving a subset of the data maintained by the primary database. In this type of environment, each of the subscribers specifies particular types or items of data (“subscribed items”) that the subscriber wants to receive and replicate from the primary database.

In current replication environments, definition of the replication environment and control over the replication environment is the responsibility of a user through execution of multiple command-line entries. Such an approach is inherently time-consuming, complicated, and error-prone, with limited flexibility to accommodate changes quickly and without error.

Accordingly, a need exists for an approach to replication environment definition and control that avoids these limitations. The present invention addresses such a need.

### BRIEF SUMMARY

Briefly stated, the invention includes system, method, computer program product embodiments and combinations and sub-combinations thereof for directing a data replication environment through policy declaration. Aspects include identifying a policy declaration defining a replication environment, and processing the policy declaration to instantiate the replication environment according to parameters established in the policy declaration.

Through the aspects, the nature of the replication itself, i.e., the type of replication to be performed and how that replication will behave, is readily defined through the policy declarations, regardless of the level at which it is directed. Further, once deployed, the replication environment is not forever bound to a particular declaration, but may have it changed at any time by simply adjusting the parameters/settings declared in the policy document. Further embodiments, features, and advantages of the invention, as well as the structure and operation of the various embodiments of the invention, are described in detail below with reference to accompanying drawings.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 illustrates a network in which the present invention, or portions thereof, can be implemented, in accordance with an embodiment of the present invention.

FIG. 2 is a block diagram illustrating workflow for directing a data replication environment through policy declaration, in accordance with an embodiment of the present invention.

FIG. 3 is flowchart illustrating an overall process for directing a data replication environment through policy declaration in accordance with an embodiment of the present invention.

FIG. 4 illustrates an example computer useful for implementing components of embodiments of the invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference Lumber.

### DETAILED DESCRIPTION

The present invention relates to a system, method, computer program product embodiments and combinations and sub-combinations thereof for providing methodology for directing a data replication environment through policy declaration.

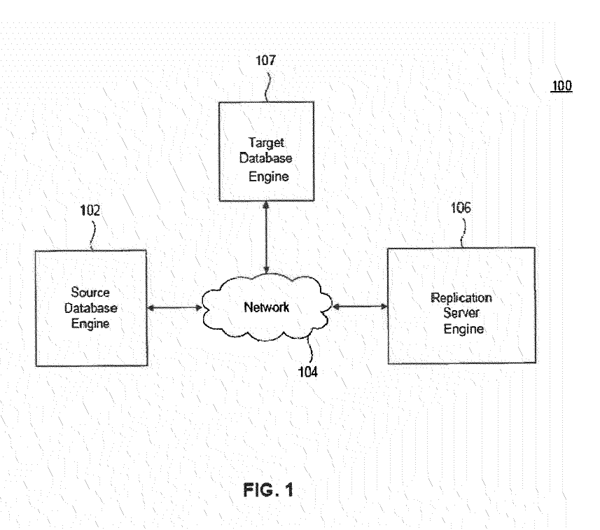

FIG. 1 illustrates a replication environment 100 in which the present invention, or portions thereof, can be implemented. A source database engine 102 is able to communicate over network 104 with replication engine 106, in accordance with an embodiment of the present invention, and is a source of transactions that modify data and are captured for replication and distribution to target database engine 107, via replication engine 106.

Network 104 can be any type of network or combination of networks such as, but not limited to, a local area network, wide area network, or the Internet. Network 104 may be any form of a wired network or a wireless network, or a combination thereof. One skilled in the relevant arts will further recognize that the network 100 can be configured in a number of ways in order to achieve the same result, and the aforementioned configuration is shown by way of example, and not limitation. For instance, in accordance with an embodiment of the present invention, source database engine 102 may be located in a single physical computing device or cluster of computing devices.

Further source database engine 102 and target database engine 107 may be any form of database and can include, but are not limited to, a device having a processor and memory for executing and storing instructions. Such a database may include software, firmware, and hardware or some combination thereof. The software may include one or more applications and an operating system. The hardware can include, but is not limited to, a processor, memory and user interface display. An optional input device, such as a mouse, stylus or any other pointing device, may be used.

In an embodiment, a publish-and-subscribe model for replicating data across the network 104 is utilized. Users “publish” data that is available in a primary database of the source database engine 102, and other users “subscribe” to the data for delivery in a target database of target database engine 107 via replication engine 106. Users can replicate both data changes (e.g., update, insert, and delete operations) and stored procedures using this method. An embodiment of the replication engine 106 is the Sybase Replication Server, which is well known and described in publicly available documents.

In current replication environments, definition of the replication environment 100 and control over the replication environment 100 is the responsibility of a user through execution of multiple command-line entries. Such an approach is inherently time-consuming, complicated, and error-prone, with limited flexibility to accommodate changes quickly and without error.

By way of example, the following multiple-command line entry creates a subscription that does not want materialization:
create subscription upd_publishers_pubs2_sub
for upd_publishers_pubs2
with replicate at SYDNEY_DS.pubs2
without materialization
go

Such manual creation is required for each subscription and must be specified to not include materialization. Further, if one wants to change the subscription, command entry is required to “drop” the subscription and then recreate it with the desired changes.

In order to alleviate current limitations in defining and controlling a replication environment, embodiments of the present invention provide for declaratively defining the nature of the replication environment with use of regulatory and behavioral policies to logically model the replication environment. These policies control the nature of the database replication during execution by enforcing agreement rules and actions.

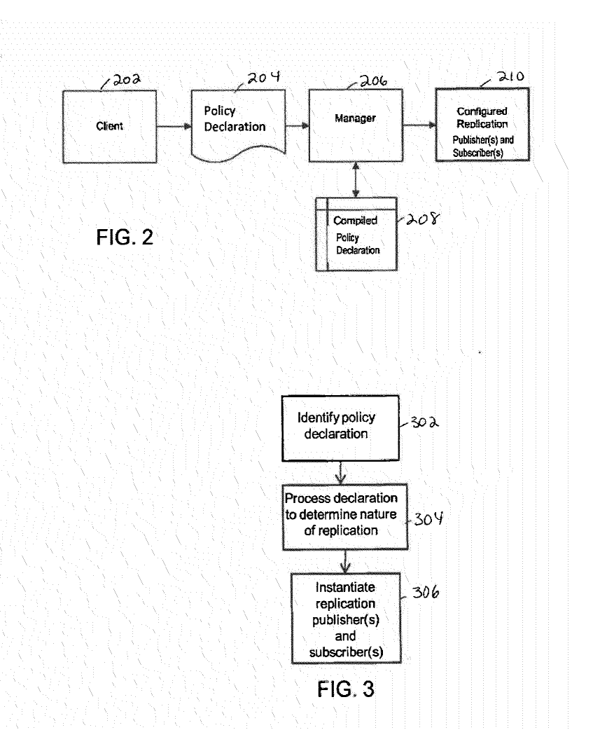

Referring now to FIG. 2, a block diagram representation of a workflow for directing a data replication environment through policy declaration in accordance with an embodiment of the invention is illustrated. In order to declaratively define the nature of the replication environment, a client 202 (e.g., a database administrator) creates a policy declaration document 204, e.g., an XML document. By way of example, in a Replication Server embodiment, the document creation occurs utilizing Sybase Control Center. The policy declaration document 204 defines the policies for replication strategy, replication behavior, and replication quality of service of the replication environment.

For example, these declarations include whether the replication strategy is to be continuous or snapshot replication. Properties of the strategies may also be specified, including a high volume adaptive replication (HVAR) indicator, as available in a Replication Server environment, the details of which are described in pending U.S. patent application Ser. No. 12/646,321, Publication No. 2011/0153568, filed Dec. 23, 2009, assigned to the assignee of the present invention for indicating how continuous replication is to be applied, and extract and load indicators for indicating snapshot replication methods. Examples of replication behavior declarations include parameters specifying whether replication is to utilize materialization, dematerialization, and a level of transactional consistency achieved (e.g., consistent, not consistent, eventually consistent). Quality of service declarations include parameters related to compliance with respect to performance boundaries and thresholds, such as latency, throughput, uptime, response time, processor usage, and service prioritization. Other attributes may also be included to direct how the replication will occur, e.g., the data flow, suspend or no-suspend, and the like.

Additionally, the declarations describe the arrangement of the data constituents of the replication environment, i.e., the data groups/publishers/subscribers/tables arrangement. In an embodiment, a data group acts as a container mechanism of publishers and subscribers and their associated tables undergoing replication. These declarations may be specified at any and/or every level, where a table precedes a subscriber value, which precedes a publisher value, which precedes a data group value. In this manner there is granular control over the replication environment, e.g., one subscriber may behave differently than another and tables within a subscriber may behave differently than another.

Operations are also declared and are applicable to all levels, with a data group operation applying to all publishers, a publisher operation applying to one publisher and affecting all subscribers of that publisher, a subscriber operation applying to one subscriber and affecting all publishers to that subscriber, and a table operation applying to a single table within a publisher or subscriber. Included in the operations are start/stop operation indications, continuous replication operation declarations, and snapshot operation declarations. Options of continuous replication operation declarations include start with or without materialization, start with no-suspend materialization, start with suspend materialization, start with HVAR processing, start with consistent replication, start with eventually consistent replication, start with inconsistent replication, as well as stop without purge or with purge (i.e., essentially dematerialization). Likewise, snapshot replication also can be started as consistent or inconsistent and stopped with or without dematerialization.

It should be appreciated that the declarations described are illustrative and not restrictive of the type and/or number of declarations possible and may include other specifications that are useful to a particular environment. For example, co-pending US Patent Application serial no ______, filed ______, entitled HYBRID DATA REPLICATION, (attorney docket # 1933.2070000), assigned to the assignee of the present invention and incorporated herein by reference in its entirety, describes a replication environment for achieving hybrid replication, the enablement and specification of which may be done through the use of the policy document described herein.

Once the creation of the document 204 is completed, a manager module 206 receiving the document 204 identifies the policy declaration (represented by block 302 in the overall flow diagram of FIG. 3) and processes the declaration to determine the nature of the replication (block 304, FIG. 3). In an embodiment, this includes consuming, compiling, and interpreting the document 204, such as using standard XML parsing tools (DOM/SAX), as is well understood in the art. interpretation of the compiled document 208 determines the nature of the replication, e.g., the number of publishers and their associated parameters, and the number of subscribers and their associated parameters, which are instantiated as the replication publisher and subscriber components 210 conforming to the declared policies of the client 202 (block 306, FIG. 3).

In this manner, the nature of the replication itself, i.e., the type of replication to be performed and how that replication will behave, is readily defined through the policy declarations, regardless of the level at which it is directed. Further, once deployed, the environment is not forever bound to a particular declaration, but may have it changed at any time by simply adjusting the parameters/settings declared in the policy document.

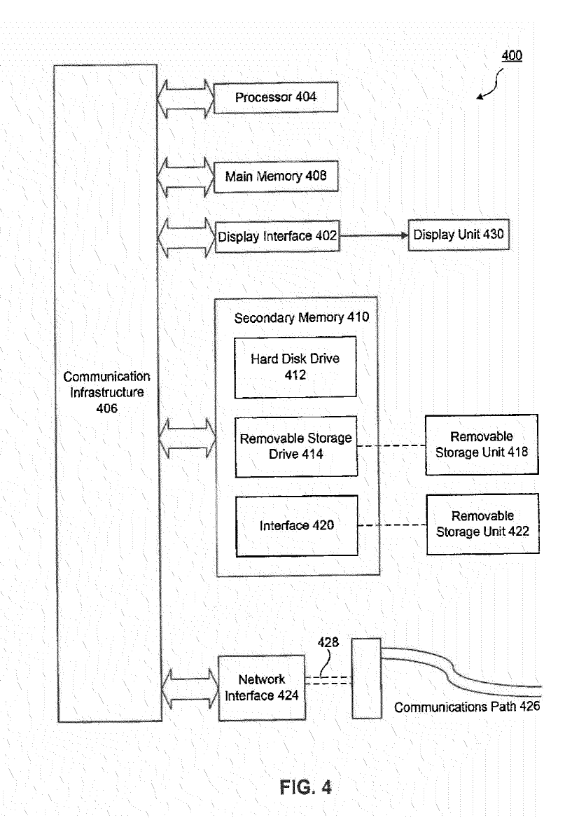

Various aspects of the present invention can be implemented by software, firmware, hardware, or a combination thereof. FIG. 4 illustrates an example computer system 400 in which the present invention, or portions thereof, can be implemented as computer-readable code. For example, the methods illustrated by the flowchart of FIG. 3, can be implemented in system 400. Various embodiments of the invention are described in terms of this example computer system 400. After reading this description, it will become apparent to a person skilled in the relevant art how to implement the invention using other computer systems and/or computer architectures.

Computer system 400 includes one or more processors, such as processor 404. Processor 404 can be a special purpose or a general purpose processor. Processor 404 is connected to a communication infrastructure 406 (for example, a bus or network).

Computer system 400 also includes a main memory 408, preferably random access memory (RAM), and may also include a secondary memory 410. Secondary memory 410 may include, for example, a hard disk drive 412, a removable storage drive 414, and/or a memory stick. Removable storage drive 414 may comprise a floppy disk drive, a magnetic tape drive, an optical disk drive, a flash memory, or the like. The removable storage drive 414 reads from and/or writes to a removable storage unit 418 in a well known manner. Removable storage unit 418 may comprise a floppy disk, magnetic tape, optical disk, etc. which is read by and written to by removable storage drive 414. As will be appreciated by persons skilled in the relevant art(s), removable storage unit 418 includes a computer usable storage medium having stored therein computer software and/or data.

In alternative implementations, secondary memory 410 may include other similar means for allowing computer programs or other instructions to be loaded into computer system 400. Such means may include, for example, a removable storage unit 422 and an interface 420. Examples of such means may include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to computer system 400.

Computer system 400 may also include a communications interface 424. Communications interface 424 allows software and data to be transferred between computer system 400 and external devices. Communications interface 424 may include a modem, a network interface (such as an Ethernet card), a communications port, a PCMCIA slot and card, or the like. Software and data transferred via communications interface 424 are in the form of signals which may be electronic, electromagnetic, optical, or other signals capable of being received by communications interface 424. These signals are provided to communications interface 424 via a communications path 426. Communications path 426 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 418, removable storage unit 422, and a hard disk installed in hard disk drive 412. Signals carried over communications path 426 can also embody the logic described herein. Computer program medium and computer usable medium can also refer to memories, such as main memory 408 and secondary memory 410, which can be memory semiconductors (e.g. DRAMs, etc.). These computer program products are means for providing software to computer system 400.

Computer programs (also called computer control logic) are stored in main memory 408 and/or secondary memory 410. Computer programs may also be received via communications interface 424. Such computer programs, when executed, enable computer system 400 to implement the present invention as discussed herein. In particular, the computer programs, when executed, enable processor 404 to implement the processes of the present invention, such as the method illustrated by the flowchart of FIG. 2. Accordingly, such computer programs represent controllers of the computer system 400. Where the invention is implemented using software, the software may be stored in a computer program product and loaded into computer system 400 using removable storage drive 414, interface 420, hard drive 412 or communications interface 424.

The invention is also directed to computer program products comprising software stored on any computer useable medium. Such software, when executed in one or more data processing device, causes a data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage device, etc.), and communication mediums (e.g., wired and wireless communications networks, local area networks, wide area networks, intranets, etc.).

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

1. A computer-implemented method for directing data replication in a database system environment, the method comprising:
identifying a policy declaration defining a replication environment declared in a hierarchical policy declaration document; and
processing the policy declaration to instantiate the replication environment according to parameters, including precedence among replication entities, established in the policy declaration.

2. The computer-implemented method of claim 1 wherein identifying further comprises identifying parameters for at least one of replication strategy, replication behavior, and replication quality of service.

3. The computer-implemented method of claim 2 wherein identifying replication strategy parameters further includes identifying parameters for at least one of continuous replication and snapshot replication strategies.

4. The computer-implemented method of claim 2 wherein identifying replication behavior parameters further includes identifying parameters for at least one of materialization, dematerialization, and a level of transactional consistency achieved.

5. The computer-implemented method of claim 2 wherein identifying replication quality of service parameters further includes identifying parameters related to compliance to performance boundaries and thresholds, including at least one of the group comprising latency, throughput, uptime, response time, processor usage, and prioritization.

6. The computer-implemented method of claim 1 wherein processing further comprises instantiating publishers, subscribers, and data groups for tables undergoing replication.

7. The computer-implemented method of claim 6 wherein the policy declaration establishes precedence among the tables, publishers, subscribers, and data groups.

8. The computer-implemented method of claim 7 wherein tables precede subscribers, subscribers precede publishers, and publishers precede data groups.

9. A system for policy-driven data replication in a database system environment, the system comprising:
a memory; and
at least one processor coupled to the memory and configured to: replicate data in a source database from at least one publisher to at least one subscriber to the data in a target database by identifying a policy declaration declared in a hierarchical policy declaration document and processing the policy declaration to instantiate configured replication components according to parameters, including precedence among replication entities, established in the policy declaration.

10. The system of claim 9, the at least one processor further configured to identify parameters for at least one of replication strategy, replication behavior, and replication quality of service.

11. The system of claim 10, the at least one processor further configured to identify parameters for at least one of continuous replication and snapshot replication strategies.

12. The system of claim 11, the at least one processor further configured to identify replication behavior parameters for at least one of materialization, dematerialization, and a level of transactional consistency achieved.

13. The system of claim 11, the at least one processor further configured to identify replication quality of service parameters related to compliance to performance boundaries and thresholds, including at least one of the group comprising latency, throughput, uptime, response time, processor usage, and prioritization.

14. The system of claim 10, the at least one processor further configured to instantiate publishers, subscribers, and data groups for tables undergoing replication.

15. The system of claim 14, wherein the policy declaration establishes precedence among the tables, publishers, subscribers, and data groups.

16. The system of claim 15, wherein tables precede subscribers, subscribers precede publishers, and publishers precede data groups.

17. A tangible computer-readable device having instructions stored thereon that, when executed by at least one computing device, causes the at least one computing device to perform operations comprising:
identifying a policy declaration defining a replication environment declared in a hierarchical policy declaration document; and
processing the policy declaration to instantiate the replication environment according to parameters, including precedence among replication entities, established in the policy declaration.

18. The computer-readable device of claim 17, the operations further comprising identifying parameters for at least one of replication strategy, replication behavior, and replication quality of service.

19. The computer-readable device of claim 18, the operations further comprising identifying parameters for at least one of continuous replication and snapshot replication strategies.

20. The computer-readable device of claim 18, the operations further comprising identifying parameters for at least one of materialization, dematerialization, and a level of transactional consistency achieved.

21. The computer readable device of claim 18, the operations further comprising identifying parameters related to compliance to performance boundaries and thresholds, including at least one of the group comprising latency, throughput, uptime, response time, processor usage, and prioritization.
